(19) United States
(12) Patent Application Publication
(10) Pub. No.: US 2005/0143916 A1
(43) Pub. Date: Jun. 30, 2005

(54) Positioning apparatus and method combining RFID, GPS and INS

(76) Inventors: In-Jun Kim, Daejon (KR); Jae-Hoon Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/858,695

(22) Filed: Jun. 1, 2004

(30) Foreign Application Priority Data
Dec. 26, 2003 (KR) 2003-97845

(51) Int. Cl. G01C 21/26

(52) U.S. Cl. 701/214; 701/213; 342/357.06

(57) ABSTRACT

Provided is an apparatus and method for positioning a mobile object by combining Radio Frequency Identification (RFID), Global Positioning System (GPS), and Inertial Navigation System (INS). The apparatus and method can acquire positioning information stably and continuously even when GPS signals are cut off by combining the RFID positioning information with INS positioning information. The positioning apparatus includes: a GPS signal receiving unit; an RFID reading unit; an INS sensing unit; a GPS/RFID selecting unit for generating selection information for a positioning algorithm based on whether GPS positioning information transmitted from the GPS signal receiving unit can be used or not and whether a tag ID is acquired in the RFID reading unit; and an integrated positioning unit for acquiring the positioning information of the mobile object by executing any one selected from a group of a GPS/INS positioning algorithm, an RFID/INS positioning algorithm, and an INS positioning algorithm based on the selection information of the GPS/RFID selecting unit.

### FIELD OF THE INVENTION

The present invention relates to a positioning apparatus and method; and, more particularly, to a positioning apparatus and method combining Radio Frequency Identification (RFID) positioning technology, Global Positioning System (GPS) and Inertial Navigation System (INS) technologies. The method combining RFID, GPS and INS technologies can acquire positioning information of a mobile object stably and continuously even when GPS signals are cut off by adding the RFID positioning technology to a positioning apparatus utilizing the GPS and INS technologies, which cannot position the mobile object perfectly in themselves, and utilizing RFID positioning information and INS positioning information.

### DESCRIPTION OF RELATED ART

As mobile telecommunication technology is developed recently, a new sort of a positioning method that can provide a new type of service is developed. Generally, a service area for utilizing positioning information is called Location-Based Service (LBS). Telematics is one of the LBS areas and the telematics technology includes vehicle positioning technology or navigation technology.

Conventional methods for acquiring positioning information include a traditional method utilizing a Global Positioning System (GPS), a method utilizing a mobile communication terminal, a method combining the GPS and an Inertial Navigation System (INS), a method combining the GPS and mobile communication terminals, a method combining the GPS, mobile communication terminals and INS.

The traditional method utilizing the GPS cannot carry out positioning in GPS shadow area, such as areas packed with buildings, high street trees, tunnels, the inside of buildings or houses, due to the cutoff of GPS signals. The method utilizing a mobile communication terminal has a problem that it has low reliability and precision due to a near-far problem, hearability, multipath, poor dilution of precision (DOP), repeater problem and the like.

The method combining the GPS and an INS which is mainly used for vehicle navigation apparatuses has a problem that positioning error occurs when GPS signals are not received for a long time due to cutoff of GPS signals and error accumulation caused by time in INS. The method combining the GPS and mobile communication terminals can provide positioning service for a short moment due to characteristics of mobile communication terminals. It also should perform positioning only with the mobile communication terminals when GPS signals are cut off, it has a problem that the acquired positioning information is inaccurate and it takes high cost.

Recently, positioning methods utilizing RFID, wireless local area network (LAN) and Ultra-wide band (UWB) technology are studied actively. As mentioned before, the conventional technologies are affected greatly by the cutoff of GPS signals. The positioning technology utilizing mobile communication network, also, is largely affected by the placement of base station and radio propagation environment. The method integrating the INS cannot eliminate the probability for error accumulation based on time completely and keeps it as a potential error causing factor.

### SUMMARY OF THE INVENTION

It is, therefore, an object of the present invention to provide a positioning apparatus and method combining Radio Frequency Identification (RFID) positioning method, a Global Positioning System (GPS) and Inertial Navigation System (INS). The apparatus and method can acquire positioning information stably and continuously utilizing the RFID positioning information and INS positioning information even when GPS signals are cut off by combining the RFID positioning technique with a positioning apparatus using the GPS and INS techniques, which cannot position the mobile object perfectly in themselves.

In accordance with an aspect of the present invention, there is provided an apparatus for positioning a mobile object in the mobile object by combining RFID, a GPS and an INS, including: a GPS signal receiving unit for receiving GPS signals from a satellite and acquiring positioning information of the mobile object; an RFID reading unit for receiving and reading an RFID tag identification (ID) transmitted from RFID tags according to movement of the mobile object; an INS sensing unit for acquiring velocity information, acceleration information and direction information of the mobile object by using a plurality of accelerating sensors and gyro sensors; a GPS/RFID selecting unit for generating selection information for a positioning algorithm based on whether GPS positioning information transmitted from the GPS signal receiving unit can be used or not and whether the RFID tag ID is acquired in the RFID reading unit; and an integrated positioning unit for acquiring the positioning information of the mobile object by executing any one selected from a group of a GPS/INS positioning algorithm, an RFID/INS positioning algorithm, and an INS positioning algorithm based on the selection information of the GPS/RFID selecting unit.

In accordance with another aspect of the present invention, there is provided a method for positioning a mobile object by combining RFID, a GPS and an INS, including the steps of: a) receiving GPS signals from a satellite and acquiring positioning information of the mobile object; b) receiving and reading an RFID tag ID transmitted from RFID tags according to movement of the mobile object; c) acquiring velocity information, acceleration information and direction information of the mobile object by using a plurality of accelerating sensors and gyro sensors; d) generating algorithm selection information for a positioning algorithm based on whether GPS positioning information acquired in the GPS signal receiving step a) can be used or not and whether the RFID tag ID is acquired; and e) acquiring the positioning information of the mobile object by executing any one selected from a group of a GPS/INS positioning algorithm, an RFID/INS positioning algorithm, and an INS positioning algorithm based on the algorithm selection information.

The positioning technology of the present invention combines the RFID technology with the GPS and INS technologies and applies the integrated technology to positioning. When GPS signals are received, positioning is carried out by using the GPS/INS(/DR) positioning filter. When GPS signals are cut off, positioning is performed by combining the RFID positioning information with the INS(/DR). This method can secure constant positioning and reliability.

Particularly, the positioning technology of the present invention can perform positioning constantly even when GPS signals are cut off by utilizing the RFID technology. It combines the RFID technology with INS/DR technology and performs positioning stably even when the GPS signals are not received for a long time.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a telematics positioning system combining a Radio Frequency Identification (RFID), Global Positioning System (GPS), Inertial Navigation System (INS), and Dead Reckoning (DR) in accordance with the present invention;

FIG. 2 is a block diagram describing a positioning apparatus combining RFID, GPS, INS and DR in accordance with an embodiment of the present invention;

FIG. 3 is a block diagram describing the positioning apparatus combining RFID, GPS, INS and DR in a double coupling method in accordance with an embodiment of the present invention;

FIG. 4 is a block diagram describing the single-coupled positioning apparatus combining RFID, GPS, INS and DR in accordance with an embodiment of the present invention;

FIG. 5 is a detailed block diagram of positioning filter depicting the single-coupled positioning apparatus combining RFID, GPS, INS and DR of FIG. 4 in accordance with an embodiment of the present invention;

FIG. 6 is a flowchart describing a positioning method combining RFID, GPS, INS and DR in a double coupling method in accordance with an embodiment of the present invention;

FIG. 7 is a flowchart illustrating a single-coupled positioning method combining RFID, GPS, INS and DR in accordance with an embodiment of the present invention; and

FIGS. 8A and 8B are flowcharts describing a method for selecting a positioning algorithm for a GPS/RFID selector in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

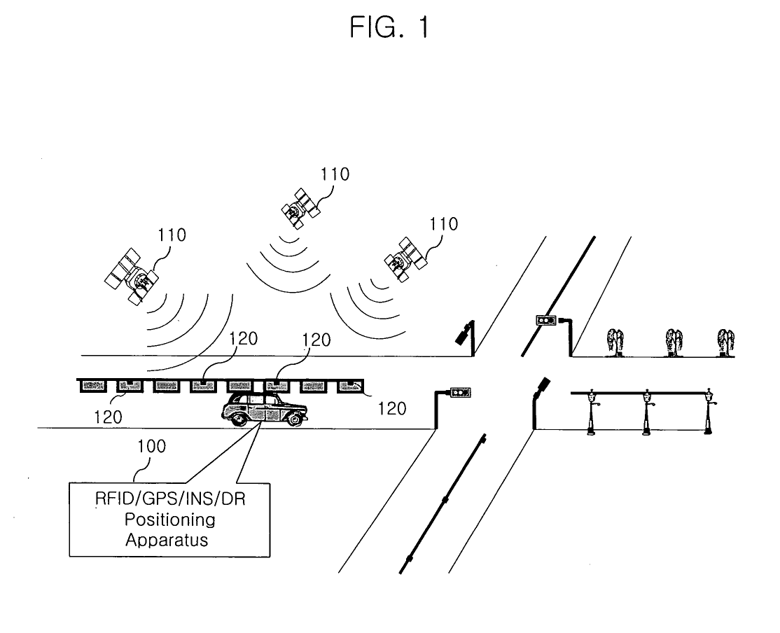

FIG. 1 is a figure illustrating a telematics positioning system combining a Radio Frequency Identification (RFID), Global Positioning System (GPS), Inertial Navigation System (INS) and Dead Reckoning (DR) in accordance with the present invention.

A positioning apparatus 100 combining RFID, GPS, INS and DR is a telematics positioning system combining an RFID, the GPS and the INS/DR navigation apparatus. The positioning apparatus 100 includes an RFID reader, a GPS receiver and an INS sensor. It is mounted on a vehicle.

The RFID tags 120 are built in a facility on a road and they stores tag identification (ID) for inquiring a position coordinates or a position from a database. The RFID tags 120 are placed within a frequency coverage of an RFID reader at predetermined intervals. They can be installed in road facilities such as median strips, guardrail, traffic signals, street trees and roads.

The RFID reader radiates frequency continuously, reads in data from an RFID tag 120 within the frequency coverage, and outputs positioning information of the RFID tag 120.

The GPS receiver receives GPS satellite signals from a satellite 110 through an antenna and outputs information on position, velocity, acceleration, heading angle of a user, and pseudorange which is a range between the satellite and the GPS receiver.

The INS sensor includes a Gyro sensor having a plurality of gyroscopes and an accelerating sensor having a plurality of accelerometer.

When the positioning system of the present invention is applied to a vehicle, a dead-reckoning (DR) sensor having a vehicle tachometer is added thereto.

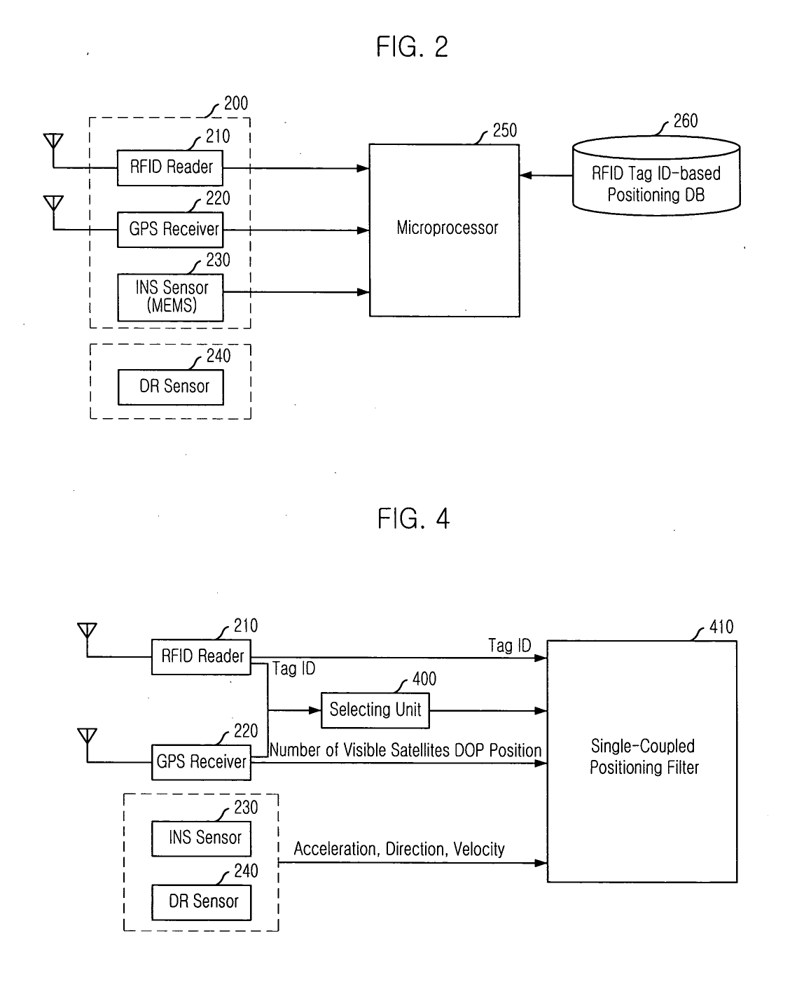

FIG. 2 is a block diagram describing a positioning apparatus combining RFID, GPS, INS and DR in accordance with an embodiment of the present invention. The positioning apparatus 200 includes an RFID reader 210, a GPS receiver 220 and an INS sensor 230.

The GPS receiver 220 receives GPS satellite signals through a GPS antenna and determines the position of a user. The RFID reader 210 radiates frequency continuously through an RFID antenna, reads data from an RFID tag 120 in the frequency coverage, and outputs the position of the RFID tag 120.

The INS sensor which is of a Micro-Electro Mechanical System (MEMS) type includes a gyro sensor having a plurality of gyroscopes and an accelerating sensor having a plurality of accelerometer.

The positioning apparatus of the present invention is mounted on a mobile object, such as a mobile terminal. When it is applied to a vehicle, a dead-reckoning (DR) sensor having a vehicle tachometer is added thereto.

A microprocessor 250 combines and processes information obtained from digital signals of the RFID, GPS, and INS/DR sensors. The RFID tag ID-based positioning database 260 stores position coordinates, i.e., positioning information, based on the identification of an RFID. The database 260 is used for inquiring the position coordinates.

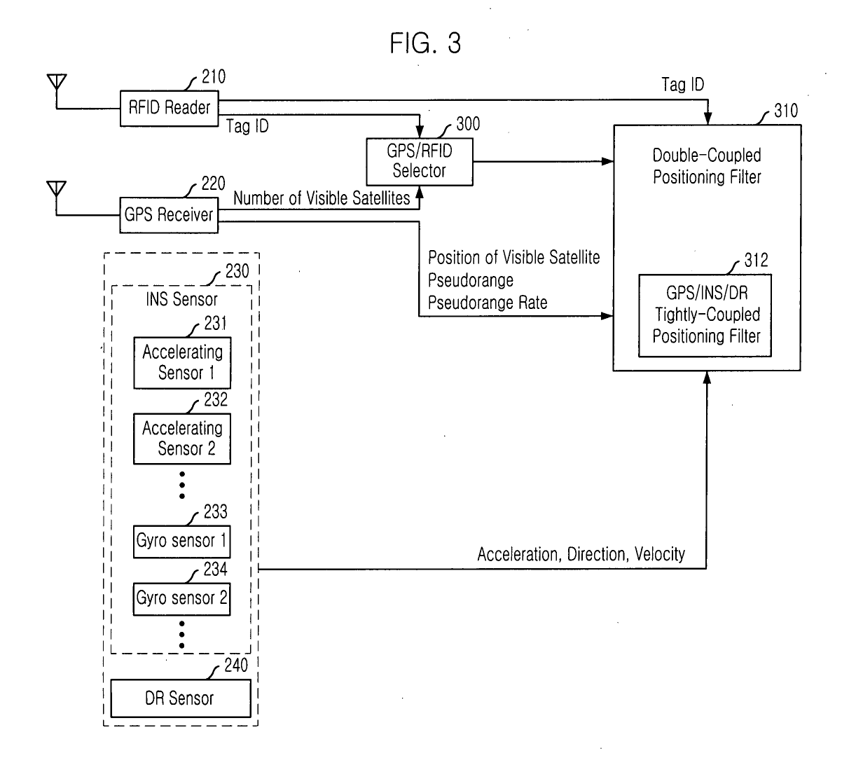

FIG. 3 is a block diagram describing the double-coupled positioning apparatus combining RFID, GPS, INS and DR in accordance with an embodiment of the present invention. The double-coupled positioning apparatus includes the RFID reader 210, the GPS receiver 220, the INS sensor 230, a GPS/RFID selector 300 and a double-coupled positioning filter 310.

The positioning apparatus is mounted on a mobile object, such as a mobile terminal. When the positioning apparatus is applied to a vehicle, the DR sensor 240 having a tachometer is added thereto. The tachometer is a device for measuring a speed of the vehicle by detecting the number of rotations made by the wheels of the vehicle.

The GPS/RFID selector 300 selects a positioning algorithm to be used by recognizing positioning signal resources, which are GPS information including the number of visible satellite and DOP, and the identification of the RFID tag. In short, the GPS/RFID selector 300 acquires the positioning information of the vehicle by carrying out the selected positioning algorithm among a GPS/INS/DR tightly-coupled positioning algorithm, an RFID/INS/DR positioning algorithm, and INS/DR positioning algorithm according to the selection information of the GPS/RFID selector 300.

The GPS/INS/DR tightly-coupled positioning filter 312 receives information on acceleration, heading angle, and velocity from the INS sensor 230 and the DR sensor 240, and it includes an accelerating filter, a direction filter and a speed filter that are used for estimating and correcting errors. It performs positioning by carrying out ordinary GPS/INS/DR tightly-coupled estimating navigation method, which is the GPS/INS/DR positioning algorithm, based on the positioning information estimated by the filters and position-related information transmitted from the GPS receiver, such as position of a visible satellite, pseudorange, and pseudorange rate.

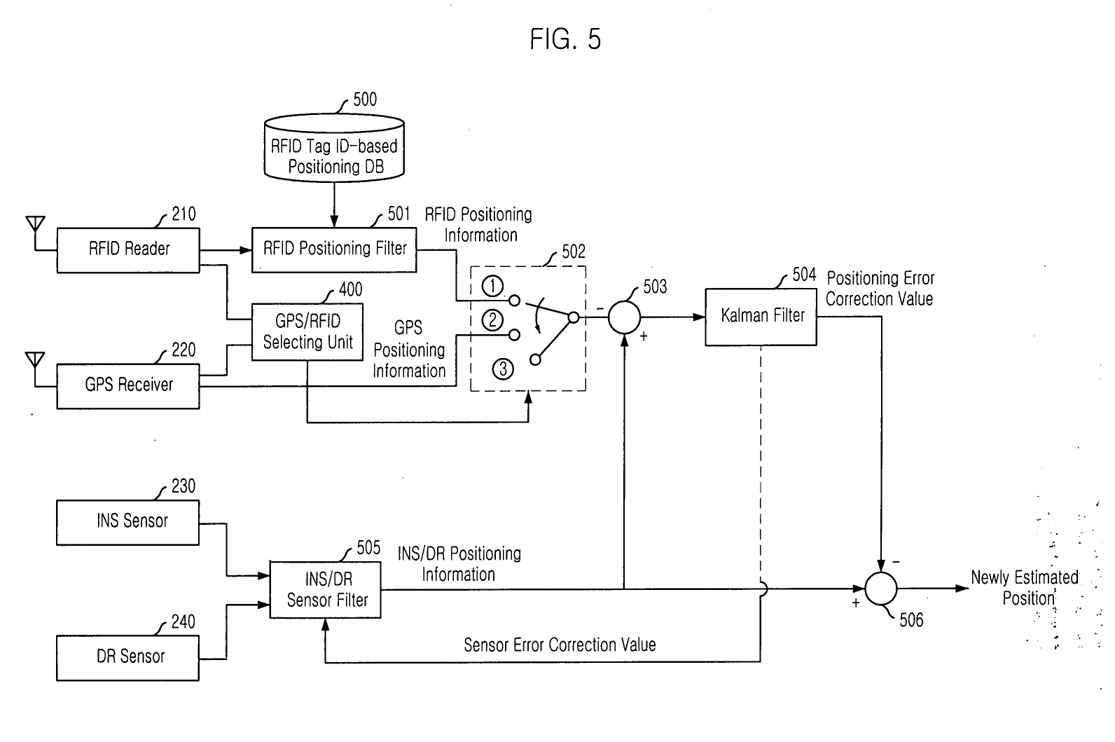

The double-coupled positioning filter 310 outputs positioning information calculated in the GPS/INS/DR tightly-coupled positioning filter 312 based on the positioning algorithm determined by the GPS/RFID selector 300. Otherwise, it calculates a new position by operating the RFID/INS/DR positioning filter just as switching is carried out on \mathring{1} in FIG. 5.

The GPS/INS/DR tightly-coupled positioning filter 312 calculates a navigation solution by utilizing the INS sensor 230 independently. The GPS receiver 120 does not calculate the navigation solution by itself and provides only the pseudorange between a visible satellite and the GPS receiver and pseudorange rate.

If the GPS/RFID selector 300 selects a positioning algorithm using RFID information, i.e., the RFID/INS positioning algorithm, the double-coupled positioning filter 310 does not use the GPS/INS/DR tightly-coupled positioning filter 312, and performs positioning by combining the RFID positioning information using RFID tag identification with the positioning information using the data of the INS/DR sensor, such as acceleration, direction and velocity.

In other words, the RFID/INS positioning algorithm acquires the RFID positioning information by using the RFID tag ID transmitted from the RFID reader 210 and acquires the INS positioning information by receiving the information on velocity, acceleration and direction from the INS sensor 230 and the DR sensor 240. Then, it finds out the position of the mobile object, such as a vehicle, by correcting the INS positioning information with the RFID positioning information.

FIG. 4 is a block diagram describing a single-coupled positioning apparatus combining RFID, GPS, INS and DR of FIG. 2 in accordance with an embodiment of the present invention.

The positioning apparatus estimates a new position by using the GPS positioning information and the RFID positioning information selectively in a single-coupled positioning filter 410 based on a positioning algorithm selected by a GPS/RFID selector 400. In short, the GPS/RFID selector 400 selects a positioning algorithm to be used by recognizing positioning signal resources including GPS information, such as the number of visible satellite and DOP, and the RFID tag ID.

The positioning information of an object, such as a vehicle, is acquired by executing a positioning algorithm selected from a group of the GPS/INS/DR loosely-coupled positioning algorithm, the RFID/INS/DR positioning algorithm, and the INS/DR positioning algorithm.

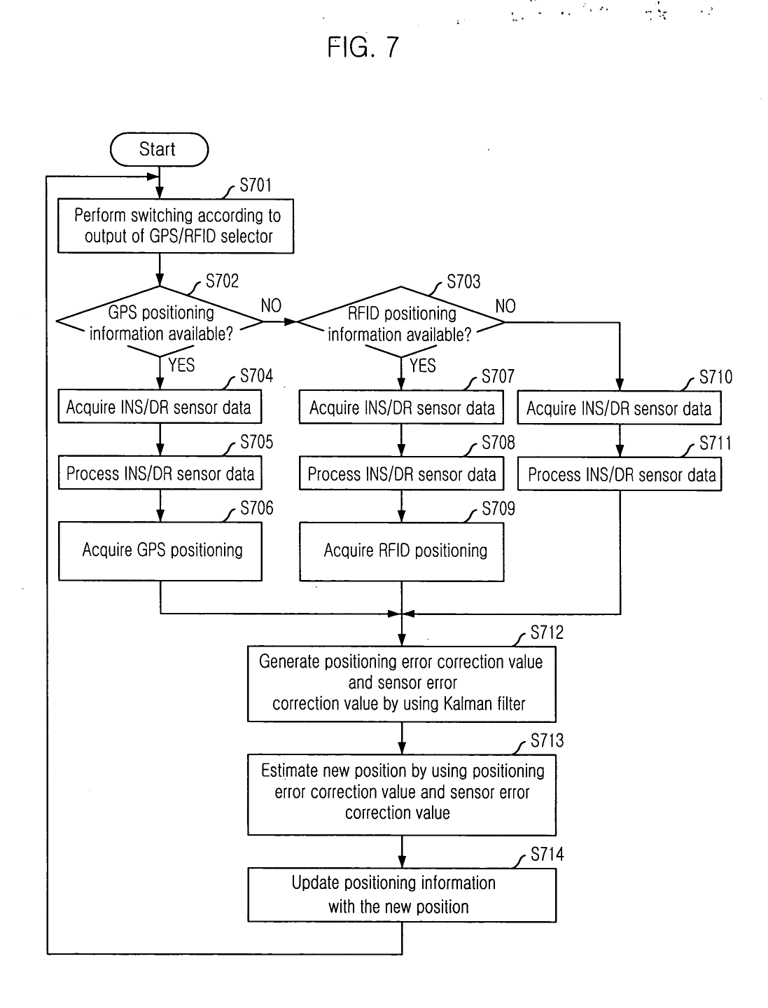

When the single-coupled positioning filter 410 receives information on acceleration, heading angle and velocity from the INS sensor 230 and the DR sensor 240, it estimates the position of a user by executing a positioning algorithm of FIG. 7 as well as GPS positioning information and RFID positioning information. The DR sensor 240 is added in case when the mobile object is a vehicle.

If the RFID/INS positioning algorithm is selected by the GPS/RFID selector 400, the RFID positioning information is acquired by using the RFID tag ID transmitted from the RFID reader 210. Then, the INS positioning information is acquired by using the velocity, acceleration and direction information transmitted from the INS sensor 230 and the DR sensor 240. The position of the mobile object, such as a vehicle, is estimated by correcting the INS positioning information with the RFID positioning information.

FIG. 5 is a detailed block diagram of positioning filter depicting the single-coupled positioning apparatus combining RFID, GPS, INS and DR of FIG. 4 in accordance with an embodiment of the present invention. A positioning algorithm to be used is determined by operating a switch 502 based on the selection of the GPS/RFID selector 400.

If the switch 502 is turned on through the \mathring{1} route, the RFID/INS/DR positioning algorithm is executed. If the switch 502 is turned on through the \mathring{2} route, the GPS/INS/DR loosely-coupled positioning algorithm is executed. If the switch 502 is turned on through the \mathring{3} route, the INS positioning algorithm is executed.

In this invention, a positioning algorithm is selected by using a switch. However, it is also possible to implement the algorithm selection in the form of software by a microprocessor, select an algorithm in the GPS/RFID selector, and execute the selected algorithm.

The RFID positioning filter 501 acquires the positioning information by retrieving the transmitted RFID tag ID in an RFID tag ID-based positioning database (DB) 500. An RFID positioning filter 501 is connected with the RFID tag ID-based positioning DB through wires or wirelessly.

An INS/DR sensor 505 calculates the position of the user by using the INS/DR data, such as acceleration, direction and velocity, transmitted from the INS sensor 230 and the DR sensor 240.

A Kalman filter 504 generates a positioning error correction value and a sensor error correction value by using signals obtained by combining the positioning information transmitted through a switch 502 and the positioning information transmitted from an INS/DR sensor filter 505. Among the two correcting values, the sensor error correction value is transmitted to the INS/DR sensor 505. The positioning information transmitted through the switch 502 is one of the RFID positioning information and the GPS positioning information (coordinates information).

Subsequently, a new position is estimated by subtracting the positioning error correction value, which is outputted from the Kalman filter 504, from the positioning information transmitted from the INS/DR sensor filter 505.

Meanwhile, although not shown in the drawings, a positioning apparatus adopting a double coupling method performs positioning by removing the \mathring{2} route in the switch 502 and making the GPS/INS/DR tightly-coupled positioning filter exist independently.

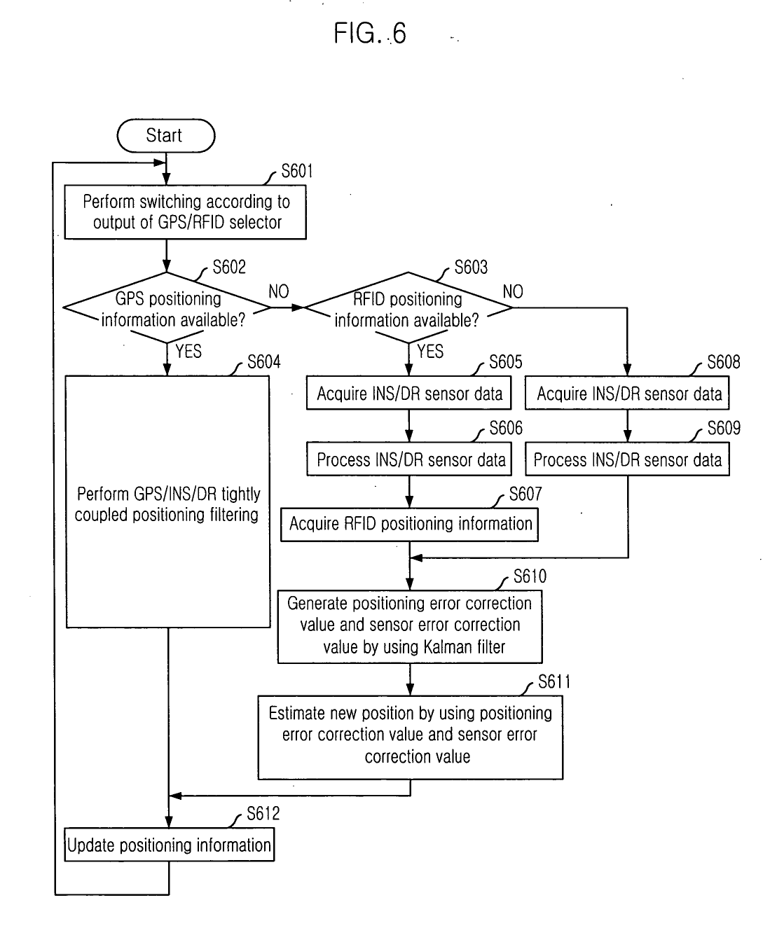

FIG. 6 is a flowchart describing a positioning method combining RFID, GPS, INS and DR in a double coupling method in accordance with an embodiment of the present invention. FIG. 6 illustrates the positioning algorithm adopting a double coupling method which is executed in the double-coupled positioning filter 310 of FIG. 3.

There are three positioning algorithms and one of them is selected according to the selection of the GPS/RFID selector 300. Followings are the process of selecting one positioning algorithm.

In a first case, at step S601, switching is performed in the switch 502 according to the selection of the GPS/RFID selector 300. At step S602, it is determined whether GPS information transmitted from the GPS/INS/DR tightly-coupled positioning filter 312 can be used for positioning. If the GPS information can be used for positioning, at step S604, new positioning information is acquired by executing the GPS/INS/DR tightly-coupled positioning filter 312. Then, at step S602, the positioning information is updated with the new positioning information.

In a second case, at steps S602 and S603, if the information that can be used in the GPS/INS/DR tightly-coupled positioning filter 312 is not the GPS information but RFID information, at step S605, the INS sensor 230 and the DR sensor 240 acquire acceleration, velocity and direction information, which will be simply referred to as INS/DR sensor data hereafter, from the accelerating sensor, gyro sensor, tacho-sensor (i.e., DR sensor) in the INS and DR sensors 230 and 240. At step S606, INS/DR positioning information is acquired by using the acquired INS/DR sensor data and performing acceleration filtering, velocity filtering and heading angle filtering, and then each sensor error is corrected by using a sensor error correction value which is transmitted from the Kalman filter.

At step S607, the RFID positioning filter (see “501”) in the double-coupled positioning filter acquires RFID positioning information by using the RFID tag ID transmitted from the RFID reader 210.

At step S610, a positioning error correction value and a sensor error correction value are generated using the Kalman filter (see “504”). Then, at step S611, a new position is estimated by using the positioning error correction value and the sensor error correction value. At step S612, the positioning information is updated with the newly estimated postion (refer to FIG. 5).

In a third case, at steps S602 and S603, if both GPS positioning information and RFID positioning information cannot be used, at step S608, the INS/DR sensor data are acquired from the accelerating sensor, gyro sensor, and tacho-sensor (i.e., DR sensor) in the INS/DR sensors 230 and 240.

At step S609, the INS/DR positioning information is acquired by using the acquired INS/DR sensor data and performing acceleration filtering, velocity filtering and heading angle filtering, and then each sensor error is corrected using the sensor error correction value transmitted from the Kalman filter (see “504”). At step S610, a positioning error correction value and a sensor error correction value are generated using the Kalman filter. At step S611, a new position is estimated using the positioning error correction value and the sensor error correction value. At step S612, the positioning information is updated with the new position (refer to FIG. 5).

FIG. 7 is a flowchart illustrating a single-coupled positioning method combining RFID, GPS, INS and DR in accordance with an embodiment of the present invention. The drawing shows the single-coupled positioning algorithm executed in the single-coupled positioning filter 410 of FIG. 4.

The positioning algorithms that can be selected based on the selection of the GPS/RFID selector 300 are three. Followings are the process for selecting one of the three positioning algorithm.

In a first case, at step S701, switching is performed. in the switch 502 based on the selection of the GPS/RFID selector 400. At step S702, if the GPS positioning information can be used in the single-coupled positioning filter 410, at step S704, the INS/DR sensor data are acquired from the accelerating sensor, gyro sensor, tacho-sensor (i.e., DR sensor) in the INS/DR sensors 230 and 240.

Subsequently, at step S705, the INS/DR positioning information is acquired by using the acquired INS/DR sensor data and performing acceleration filtering, velocity filtering and heading angle filtering, and then each sensor error is corrected by using a sensor error correction value transmitted from the Kalman filter.

At step S706, the GPS positioning information is acquired from the GPS receiver 220 and transmitted to the Kalman filter 504. At step S712, the Kalman filter 504 generates a positioning error correction value and a sensor error correction value by using the INS/DR positioning information and the GPS positioning information.

At step S713, the single-coupled positioning filter 410 estimates a new position by using the positioning error correction value and the sensor error correction value. At step S714, the positioning information is updated with the new position (refer to FIG. 5).

In a second case, at step S702, if the GPS positioning information cannot be used and the RFID information can be used in the single-coupled positioning filter 410, at step S707, the INS/DR sensor data are acquired from the accelerating sensor, gyro sensor and tacho-sensor (i.e., DR sensor) in the INS/DR sensors 230 and 240.

Subsequently, at step S708, the INS/DR positioning information is acquired by using the acquired INS/DR sensor data and performing acceleration filtering, velocity filtering and heading angle filtering, and then each sensor error is corrected by using a sensor error correction value transmitted from the Kalman filter.

At step S709, the RFID positioning filter acquires the RFID positioning information by using RFID tag ID transmitted from the RFID reader 210 and transmits it to the Kalman filter 504. At step S712, the Kalman filter 504 generates a positioning error correction value and a sensor error correction value by using the INS/DR positioning information and the RFID positioning information.

At step S713, the single-coupled positioning filter 410 estimates a new position by using the positioning error correction value and the sensor error correction value. Then, at step S714, the positioning information is updated with the new position (refer to FIG. 5).

In a third case, at steps S702 and S703, both GPS positioning information and the RFID positioning information cannot be used, at step S710, the INS/DR sensor data are acquired from the accelerating sensor, gyro sensor and tacho-sensor (i.e., DR sensor) in the INS/DR sensors 230 and 240.

At step S711, the INS/DR positioning information is acquired by using the acquired INS/DR sensor data and performing acceleration filtering, velocity filtering and heading angle filtering, and then each sensor error is corrected by using a sensor error correction value transmitted from the Kalman filter.

At step S712, the Kalman filter 504 generates a positioning error correction value and a sensor error correction value by using the INS/DR positioning information.

At step S713, the single-coupled positioning filter 410 estimates a new position by using the positioning error correction value and the sensor error correction value. Then, at step S714, the positioning information is updated with the new position (refer to FIG. 5).

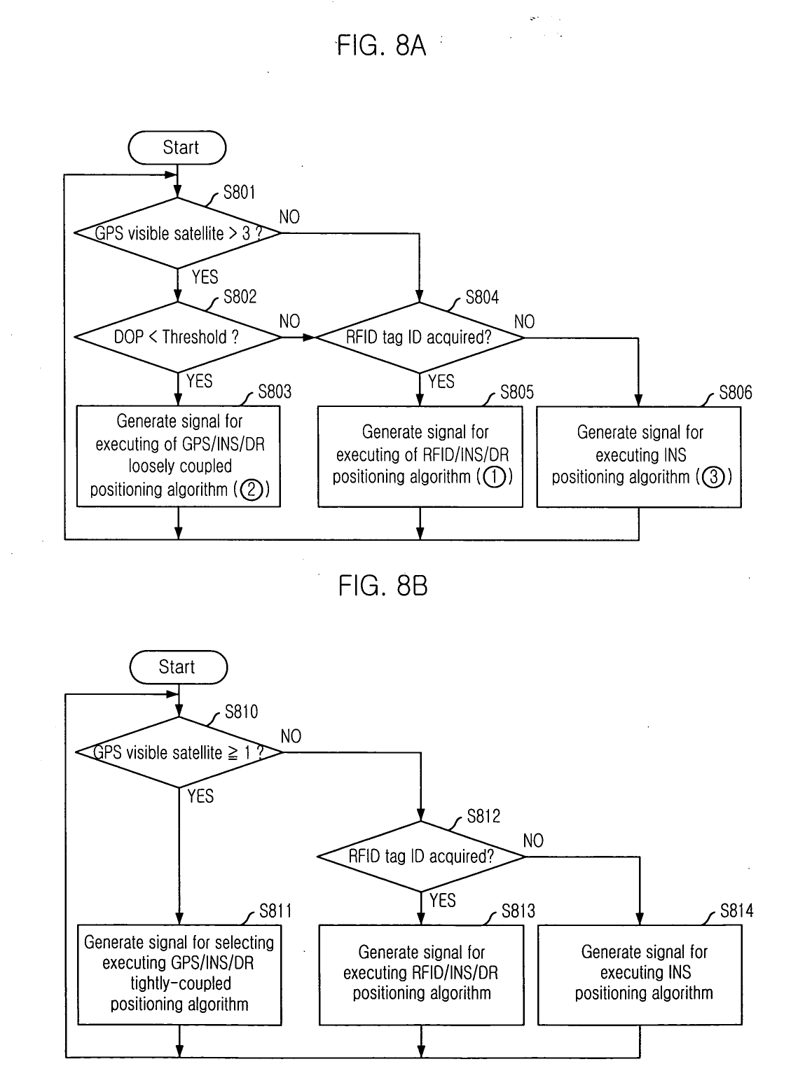

FIGS. 8A and 8B are flowcharts describing a method for selecting a positioning algorithm for a GPS/RFID selector in accordance with an embodiment of the present invention. FIG. 8A presents a process for selecting the single-coupled positioning algorithm in the GPS/RFID selector 400.

At step S801, it is checked whether the number of visible GPS satellite is more than 3 and, at step S802, it is checked if the dilution of precision (DOP) is smaller than a threshold value. If the number of visible GPS satellite is more than 3 and the DOP is smaller than the threshold value, at step S803, a signal for selecting a GPS/INS/DR loosely-coupled positioning algorithm is generated. The signal controls the switch to make the \mathring{2} route.

Meanwhile, if the number of visible GPS satellite is smaller than 3 and the DOP is larger than the threshold value, at step S804, it is checked whether RFID positioning information is acquired. If the RFID positioning information is acquired, a signal for selecting an RFID/INS/DR positioning algorithm is selected. The signal controls the switch to make the \mathring{1} route.

If the RFID positioning information is not acquired, a signal for executing an INS positioning algorithm is selected. The signal controls the switch to make the \mathring{3} route.

FIG. 8B illustrates an algorithm selecting process of the GPS/RFID selector 300 in a double coupling method. At step S810, it is checked whether the number of visible GPS satellite is more than 1. If the number of visible GPS satellite is more than 1, at step S811, a signal for selecting a GPS/INS/DR tightly-coupled positioning algorithm is generated.

Meanwhile, if there is no GPS visible satellite, at step S812, it is checked whether RFID positioning information is acquired. If the RFID positioning information is acquired, a signal for selecting the RFID/INS/DR positioning algorithm is generated. If the RFID positioning information is not acquired, at step S814, a signal for selecting the INS positioning algorithm is generated.

In accordance with the present invention, positioning can be performed by selecting the combination of GPS/INS/DR and the combination of RFID/INS/DR based on whether GPS signals are received or not. The coupling method used for the positioning can be one of a double-coupled positioning method and a single-coupled positioning method.

The positioning technology of the present invention can perform positioning continuously regardless of the reception of the GPS signals. It performs positioning in an area where it can access to the RFID tags by not depending on the GPS and cooperating with the INS. The DR sensor can be utilized additionally only when the RFID/GPS/INS/DR positioning apparatus 100 is set up in a vehicle.

The positioning method of the present invention can be embodied as a program and stored in a computer-readable recording medium, such as CD-ROM, RAM, ROM, floppy disks, hard disks, magneto-optical disks and the like.

In accordance with the present invention, the positioning apparatus and method combining the RFID network, GPS and INS performs positioning by cooperating the INS with RFID or GPS. The positioning can be performed stably by removing error accumulation effect based on time by using the RFID.

In accordance with the present invention, a positioning apparatus combining the RFID and INS can place the RFID tags at wide intervals, thus providing spatial and economical efficiency.

An RFID tag network of the present invention can be formed in all environments. It also has such advantages that the diverse services can be provided and the services can be expanded and that the cost for constructing and maintaining the RFID tag network is small. Therefore, it can acquire positioning information of a user easily in a ubiquitous computing environment. In addition, since the RFID tags can include geographical information as well as positioning data, additional services can be activated by the diverse types of data provided by the RFID tags.

An RFID/GPS/INS terminal can be miniaturized. Thus, if it is integrated with a mobile communication terminal, a portable communication and positioning terminal can be realized.

Since the present invention utilizes the RFID network, GPS and INS, solves the problems of the conventional method using mobile communication signals for positioning, such as the problem caused by a frequency environment, problems caused by the placement of base stations and repeaters, technological contradiction between the communication function and the positioning function, enormous infrastructure construction cost, and unsatisfactory positioning performance. Therefore, it can bring about the effects of constant positioning, stability in positioning, high usability and low cost.

While the present invention has been described with respect to certain preferred embodiments, it will be apparent to those skilled in the art that various changes and modifications may be made without departing from the scope of the invention as defined in the following claims.

1. An apparatus for positioning a mobile object in the mobile object by combining Radio Frequency Identification (RFID), a Global Positioning System (GPS) and an Inertial Navigation System (INS), comprising:
a GPS signal receiving means for receiving GPS signals from a satellite and acquiring GPS positioning information of the mobile object;
an RFID reading means for receiving and reading an RFID tag identification (ID) transmitted from RFID tags according to movement of the mobile object;
an INS sensing means for acquiring velocity information, acceleration information and direction information of the mobile object by using a plurality of accelerating sensors and gyro sensors;
a GPS/RFID selecting means for generating selection information for a positioning algorithm based on whether the GPS positioning information transmitted from the GPS signal receiving means is used or not and whether the RFID tag ID is acquired in the RFID reading means; and
an integrated positioning means for acquiring positioning information of the mobile object by executing any one selected from a GPS/INS positioning algorithm, an RFID/INS positioning algorithm, and an INS positioning algorithm based on the selection information of the GPS/RFID selecting means.

2. The apparatus as recited in claim 1, wherein whether the GPS positioning information can be used or not in the GPS/RFID selecting means is determined by the number of visible satellites transmitted from the GPS signal receiving means.

3. The apparatus as recited in claim 2, wherein the GPS/RFID selecting means generates selection information for executing a GPS/INS tightly-coupled positioning algorithm, if the GPS positioning information can be used;
generates selection information for executing a RFID/INS positioning algorithm, if the GPS positioning information is not used but the tag ID information is acquired; and
generates selection information for executing an INS positioning algorithm, if the GPS positioning information is not used and the tag ID information is not acquired.

4. The apparatus as recited in claim 1, wherein whether the GPS positioning information is used or not in the GPS/RFID selecting means is determined by using information on dilution of precision (DOP) and the number of visible satellites transmitted from the GPS signal receiving means.

5. The apparatus as recited in claim 4, wherein the GPS/RFID selecting means generates selection information for executing a GPS/INS loosely-coupled positioning algorithm, if the GPS positioning information is used;
generates selection information for executing a RFID/INS positioning algorithm, if the GPS positioning information is not used but the tag ID information is acquired; and
generates selection information for executing an INS positioning algorithm, if the GPS positioning information is not used and the tag ID information is not acquired.

6. The apparatus as recited in claim 1, wherein the INS sensing module further includes a tacho-sensing means, if the moving object is a vehicle.

7. The apparatus as recited in claim 6, wherein the RFID/INS positioning algorithm measures the position of the mobile object by acquiring RFID positioning information out of the RFID tag ID transmitted from the RFID reading means, acquiring INS positioning information out of the velocity, acceleration and direction information transmitted from the INS sensing means, and correcting the INS positioning information with the RFID positioning information.

8. The apparatus as recited in claim 6, wherein the RFID tags are set up in a road facility at a predetermined interval to be in frequency coverage of the RFID reading means.

9. A method for positioning a mobile object by combining Radio Frequency Identification (RFID), a Global Positioning System (GPS) and an Inertial Navigation System (INS), comprising the steps of:
a) receiving GPS signals from a satellite and acquiring GPS positioning information of the mobile object;
b) receiving and reading an RFID tag identification (ID) transmitted from RFID tags according to movement of the mobile object;
c) acquiring velocity information, acceleration information and direction information of the mobile object by using a plurality of accelerating sensors and gyro sensors;
d) generating algorithm selection information for a positioning algorithm based on whether GPS positioning information acquired in the GPS signal receiving step a) is used or not and whether the RFID tag ID is acquired; and
e) acquiring the positioning information of the mobile object by executing any one selected from a GPS/INS positioning algorithm, an RFID/INS positioning algorithm, and an INS positioning algorithm based on the algorithm selection information.

10. The method as recited in claim 9, wherein whether the GPS positioning information can be used or not in the algorithm selecting step d) is determined by using information on the number of visible satellites.

11. The method as recited in claim 10, wherein the algorithm selecting step d) includes the steps of:
d1) determining whether the GPS positioning information is used and whether the RFID tag ID is acquired;
d2) generating algorithm selection information for executing a GPS/INS tightly-coupled positioning algorithm, if the GPS positioning information is used;
d3) generating algorithm selection information for executing a RFID/INS positioning algorithm, if the GPS positioning information is not used but the tag ID information is acquired; and
d4) generating algorithm selection information for executing an INS positioning algorithm, if the GPS positioning information is not used and the tag ID information is not acquired.

12. The method as recited in claim 9, wherein whether the GPS positioning information is used or not in the algorithm selecting step d) is determined by using information on dilution of precision (DOP) and the number of visible satellites.

13. The method as recited in claim 12, wherein the algorithm selecting step d) includes the steps of:
d5) determining whether the GPS positioning information is used and whether the RFID tag ID is acquired;
d6) generating algorithm selection information for executing a GPS/INS loosely-coupled positioning algorithm, if the GPS positioning information is used;
d7) generating algorithm selection information for executing a RFID/INS positioning algorithm, if the GPS positioning information is not used but the tag ID information is acquired; and
d8) generating algorithm selection information for executing an INS positioning algorithm, if the GPS positioning information is not used and the tag ID information is not acquired.

14. The method as recited in claim 9, wherein in the step c), vehicle velocity information is further acquired with a tachometer, if the moving object is a vehicle.

15. The method as recited in claim 14, wherein the RFID/INS positioning algorithm includes the steps of:
acquiring RFID positioning information based on the RFID tag ID ;
acquiring INS positioning information based on the velocity, acceleration and direction information;
correcting the INS positioning information based on the RFID positioning information by using a Kalman filter.
